(19) United States
(12) Patent Application Publication
(10) Pub. No.: US 2017/0102211 A1
(43) Pub. Date: Apr. 13, 2017

(54) OPERATION COMPUTER SYSTEM

(71) Applicant: MBDA Deutschland GmbH, Schrobenhausen (DE)

(72) Inventors: Michael GRABMEIER, Rosenheim (DE); Konrad RUISINGER, Thierhaupten (DE); Florian NEBEL, Olching (DE)

(21) Appl. No.: 15/287,291

(22) Filed: Oct. 6, 2016

(30) Foreign Application Priority Data
Oct. 7, 2015 (DE) 10 2015 012 971.6

(51) Int. Cl. F41G 5/14; F41G 3/16; F41G 5/26; G05B 19/042; G05B 19/414

(52) U.S. Cl. CPC F41G 5/14; G05B 19/042; G05B 19/414; F41G 5/26; F41G 3/165; G05B 2219/2637

(57) ABSTRACT

A portable operation computer system, with particular application for military operations, including a control computer with a CPU, a display and control unit and at least one data interface, and including external components which can be connected to the at least one data interface of the control computer. The CPU is configured, after the control computer has been switched on or after an external component has been connected, to check whether the at least one data interface is connected to at least one of the external components and, if applicable, to which external component each data interface is directly or indirectly connected, and, depending on the result of this check, to automatically select an operating mode for the control computer from a plurality of stored operating modes and to configure the control computer and/or software running on the control computer accordingly.

### CROSS-REFERENCE TO RELATED APPLICATION

This application claims priority to German Patent Application DE 10 2015 012 971.6 filed Oct. 7, 2015, the entire disclosure of which is incorporated by reference herein.

### TECHNICAL FIELD

The present disclosure relates to a portable or mobile operation computer system which is suitable in particular, but not only, for military operations.

### BACKGROUND

In order to carry out operations, in particular military operations, it is necessary, before planning the operation, to create an overview of the area of operations. By the information recorded, the operation is planned by determining the specific operating site and the routes for transporting people and materials to the operating site as well as determining the self-protection of the troops located at the operating site and the specific operation task. The operation planning further includes the requirements concerning, and the operation tasks for replenishing supplies, communication and medical services. After the operation has been planned, the operation is then carried out on the basis of the operation plan.

From the reconnaissance of the area of operations, to carrying out the operation task, information is collected and passed on, whereby different information media are used, and a plurality of what are known as media disruptions occur. In particular when it is necessary, due to changes in constraints, to change the operation plan, the media disruptions cause considerable time delays.

In the case of ongoing operations, the following disadvantages are known:
Information flows between the separate task areas (reconnaissance, operation planning, carrying out the operation, etc.) by changing communication media (computers, paper, analogue measuring devices). Consequently, media disruptions occur, as a result of which transmission errors can creep in, important information can go missing, and the flow can slow down.
In command, information and reporting systems, operation documents are regularly created and passed on in paper form. Furthermore, the manual method of documenting reconnaissance results is also used in maps.
In the cabins of operation vehicles, often only a rudimentary vehicle orientation system or a GPS-based vehicle navigation system is installed, into which the marching routes generated by the operation planning must be input manually.
Additional planning results of the operation planning, such as engineering stops, marching and refuelling breaks, the refuelling schedule, the reloading schedule, the physical protection schedule, the dispersal area, the accommodation area, the baggage area, the assembly area, the provision plan, are visualised in real (paper) maps and not using devices.
The onboard diagnostic functions of the operation vehicles are not used for operation purposes.
Although a portable maintenance aid (PMA) can be provided, which is intended to support military users in equipment maintenance tasks (for example of the weapon system), this means that the PMA must be carried along as a separate device.
It is not possible to test the ammunition before loading the starting device or when the starting device has already been loaded.
No onboard training function is implemented for stand-alone operation or for networked operation in the starting device for the ammunition.

### SUMMARY

A problem addressed by the present disclosure is thus that of indicating an operation computer system by which, from the reconnaissance of a potential area of operations to the final execution of the operation, it is possible to achieve a flow of information between all those involved without any media disruptions, and which can be used in a flexible manner.

An operation computer system according to the disclosure herein, which is provided in particular but not exclusively for military operations, is provided with at least one control computer, which comprises a CPU, a display and control unit and at least one data interface, and with a plurality of external components which can be connected—directly or indirectly—to the at least one data interface of the control computer. In this case, the CPU is configured, after the control computer has been switched on, to check whether the at least one data interface is directly or indirectly connected to at least one of the external components and, depending on the result of this check, to automatically select an operating mode for the control computer from a plurality of operating modes stored in storage of the control computer and to configure the control computer and/or software running on the control computer accordingly.

This automatic configuration, according to the disclosure herein, of the control computer or the software running on the control computer depending on the external components which are connected to the control computer make it possible to use a single type of control computer throughout the entire course of the operation, whereby each user of the control computer does not require specific training with respect to the configuration of the control computer or the software running thereon. The control computer thus automatically changes the properties thereof depending on the components which are connected thereto, and accordingly offers each user only the input and display options that are required for the current use. The training required by the users can therefore be limited to the tasks which are assigned to each user, without a plurality of different computers being required. In addition, the operation computer system according to the disclosure herein, which carries out all the data communication of an operation by a single type of control computer, makes it possible for no media disruptions to occur during the transmission of information.

It is advantageous for one of the external components to be formed of a satellite navigation receiver. Thus, the control computer which is connected to the component can be inserted in a mobile manner, in the simplest way possible, for reconnaissance.

It is particularly advantageous for one of the external components to be formed of an operation vehicle computer which is provided in an operation vehicle that is designed for coupling to the control computer and that is provided with an interface unit for connection to a data interface of the control computer, whereby the operation vehicle computer comprises a vehicle CPU which can be connected to the control computer by the interface unit and the data interface. In this variant, the control computer can be implemented in an operation vehicle quickly and smoothly, and the existing vehicle computer in the operation vehicle becomes an integral component of the operation computer system.

In this case, it is advantageous for the operation vehicle computer to be equipped with at least one vehicle interface which can be or is connected for data transmission between the control computer that is connected to the operation vehicle computer, and at least one vehicle component of the operation vehicle. As a result, vehicle components which are already present, such as odometers, can be integrated into the operation computer system.

It is also advantageous for the vehicle component which is or can be connected to the vehicle interface to be formed of a maintenance and diagnostic computer of the vehicle.

It can also be advantageous for the operation vehicle computer to be equipped with at least one weapon system interface which can be connected to at least one weapon system component of the weapon system for data transmission between a weapon system and the control computer, which is connected to the operation vehicle computer. This embodiment is advantageous in particular when the operation vehicle is armed or is part of a weapon system.

In this case, the weapon system component which can be connected to the weapon system interface is preferably formed of a control of the weapon system. This allows the vehicle crew to stay in the protected and frequently armored interior of the vehicle and to operate the weapon system by the control computer.

If the weapon system component which can be connected to the weapon system interface is formed of a maintenance and diagnostic computer of the weapon system and/or of the ammunition contained in the weapon system, for example a missile, then the weapon system and/or the ammunition of the crew located in the protected vehicle can undergo maintenance and a function test without requiring a separate maintenance and test computer to be connected.

It is also advantageous for the weapon system component which can be connected to the weapon system interface to be formed of a test and/or training apparatus of the weapon system and/or of the ammunition contained in the weapon system. As a result, it is not necessary for an additional test and training computer to be carried along.

If the operation vehicle computer is equipped with at least one navigation interface, which can be connected to at least one navigation device component of the at least one navigation device for data transmission between at least one internal or external navigation device of the operation vehicle and the control computer which is connected to the operation vehicle computer, then the navigation device which is provided in the vehicle can be used, and marching routes worked out for example from the operation planning can be loaded directly into the navigation system of the vehicle by the control computer.

It is also advantageous for the operation vehicle computer to be equipped with or to be able to be connected to at least one communication device which can be connected to at least one communication component of the at least one external operation control center for data transmission between at least one external operation control center and the control computer, which is connected to the operation vehicle computer. As a result, a direct and optionally also permanent data transmission connection can be established between the control computer and the operation control center. A communication interface of this type which has the ability to send and receive data can alternatively also be directly connected to one of the data interfaces of the control computer. This ability of the communication device to send and receive data includes for example the ability for communication while stationary and while moving via tactical radio (VHF/UHF), via short-wave radio (HF) or by military or civil satellite communication systems.

It is also advantageous for the operation vehicle computer to comprise at least one monitoring system interface which can be connected to at least one monitoring component of the monitoring system for data transmission between at least one monitoring system and the control computer, which is connected to the operation vehicle computer. A monitoring system of this type can be for example an optical monitoring system (comprising at least one image recording device), an acoustic monitoring system (for example a sonar) or a LIDAR or RADAR monitoring system (for example a radar range measurement aid). A monitoring system of this type can alternatively also be able to be directly connected to one of the data interfaces of the control computer.

Preferably, the monitoring component which can be connected to the monitoring system interface is formed of a missile equipped with a reconnaissance device, for example a drone, of the monitoring system. In this case, the missile can also be controlled by the control computer, and the information recorded by the reconnaissance device is transmitted to the control computer as a data stream. The control computer can thus display, on the display device thereof, for example an image or video recorded by an image recording device on board the missile.

The direct and the indirect transmission of the data between the control computer and the various external components and from the components to the control computer can take place not only via wired connections, but preferably also wirelessly.

For that reason, it is particularly advantageous for encryption and decryption units to be provided, which are configured to encrypt a data stream which is sent via the respective connections between the control computer and the external component, between the control computer and the operation vehicle computer and/or between the operation control computer and the external component, and to decrypt a data stream which is received via the respective connections. As a result, not only is the security against interception increased, but the risk of manipulated data from outside creeping in is also reduced.

It is also advantageous for the reconnaissance device which records data to be provided, which each comprise a data-recording component which can be connected to the control computer and/or to the operation vehicle computer for data transmission. This makes it possible for example to use directional binoculars which record data, the recorded data of which is then transmitted to the control computer.

The core of the disclosure herein thus lies in forming an integrated operation computer system from components which are present in part and are already used currently in isolation for operation planning or also from components which are currently used for other purposes (for example a vehicle maintenance computer), the core of which is formed by the control computer which is automatically configured depending on the components which are directly or indirectly connected (by wires or in a wireless manner).

### BRIEF DESCRIPTION OF THE DRAWINGS

Preferred embodiments of the disclosure herein with additional configuration details and further advantages will be described in greater detail and explained below with reference to the accompanying drawings.

In the drawings:

FIG. 1 is a schematic view of a control computer of an operation computer system according to the disclosure herein;

FIG. 2 shows the control computer from FIG. 1, comprising a directly connected external component;

FIG. 3 shows the control computer from FIG. 1, which is connected to an operation vehicle computer;

FIG. 4 shows the combination, which is shown in FIG. 3, of a control computer and an operation vehicle computer comprising external components which are indirectly connected to the control computer by the operation vehicle computer.

### DETAILED DESCRIPTION

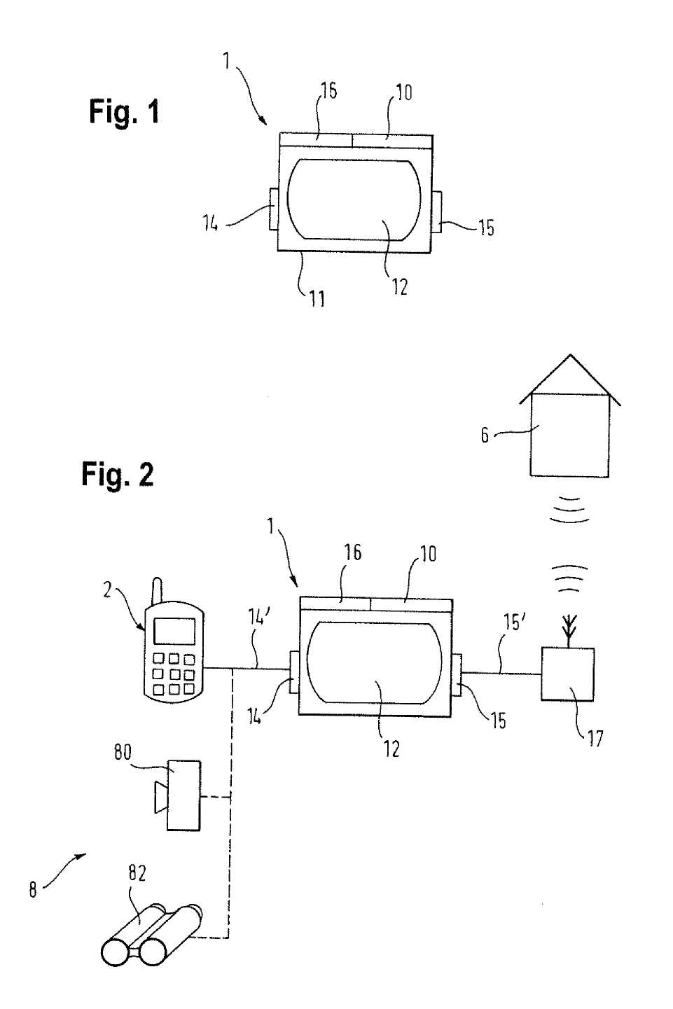

FIG. 1 is a schematic view of a control computer 1 of an operation computer system according to the disclosure herein. The control computer 1 is a portable computer which has a similar design to a toughbook, and is therefore mobile and portable. The control computer 1 is thus provided with a housing 11 which is suitable for rough military use, in which a CPU 10, a storage 16 (such as an electronic storage) and a display and control unit 12, for example a touch screen, are provided. In addition, in the example shown, the control computer 1 is provided with two data interfaces 14, 15, wherein also only one data interface or more than two data interfaces can be provided.

The data interfaces 14, 15 (and optionally additional data interfaces) preferably have standardized designs so that a plurality of different external components can be connected to the control computer 1 by the data interfaces 14, 15.

FIG. 2 shows, by way of example, how a mobile satellite navigation receiver 2, which is formed for example of a handheld device, is connected to the data interface 14. By this data communication connect 14′, for example the positional data of a current location detected by the satellite navigation receiver are transmitted to the control computer 1. In addition, it can be provided that the control of the portable satellite navigation receiver 2 is made possible by the control unit 12 of the control computer 1.

The combination, which is shown in FIG. 2, of the control computer 1 and the satellite navigation receiver 2 which is directly connected thereto already forms a unit, which can be inserted in a mobile manner separately, within the portable operation computer system according to the disclosure herein.

By this unit composed of a portable control computer 1 and a portable satellite navigation receiver 2, it is possible for example to carry out the reconnaissance of a potential area of operations without a specially equipped vehicle being required, and therefore the unit shown in FIG. 2 can also be used in a civil vehicle, for example a rental car. The unit shown in FIG. 2 can equally be carried along by a non-motorized reconnaissance team, since it is portable and suitable for mobile use.

The connection of the satellite navigation receiver 2 to one of the data interfaces 14, 15 means that the control computer 1 is automatically configured into an operating mode which makes it possible to carry out any task which should be able to be carried out by the directly connected satellite navigation receiver 2. For this purpose, the control computer 1 or the software running thereon is configured in such a way that, after the control computer has been switched on, a check is carried out as to whether the at least one data interface 14, 15 is connected to at least one external component. If the result of this check is positive, a check is consequently carried out as to which external component each data interface 14, 15 is directly or indirectly connected to. In the present case of FIG. 2, the control computer 1 or the software running thereon thus detects that an external component is connected to the data interface 14, and that the external component is a portable satellite navigation receiver 2.

By this information, the software running on the control computer 1 can select the operating mode, from a plurality of operating modes which are stored for example in the storage 16, for example as a database, which is predetermined for the combination of a control computer 1 and a portable satellite navigation receiver 2 which is shown in FIG. 2.

Checking the data interfaces 14, 15 and the external components which may be connected thereto can be carried out not only automatically after the control computer has been switched on, but also for example when an external component has just been connected to one of the data interfaces 14, 15. In addition, it can also be provided that an operator can input a command for automatic configuration into the control unit 12, for example by actuating a switch or push-button which is virtually displayed on the control unit 12.

Instead of or in addition to the satellite navigation receiver 2, reconnaissance devices forming additional reconnaissance devices 8 can be connected to the control computer 1, for example cameras 80 or directional binoculars 82 provided with data capturing devices, which form external components, and the recorded data of which is transmitted to the control computer 1 via the interface 14.

In FIG. 2, the data interface 15 of the control computer 1 is connected to a data transmission and data receiver 17 via a data communication connection 15′, by which means it is possible, when carrying out reconnaissance of collected data, to transmit data to a central operation control center 6 and to receive data therefrom.

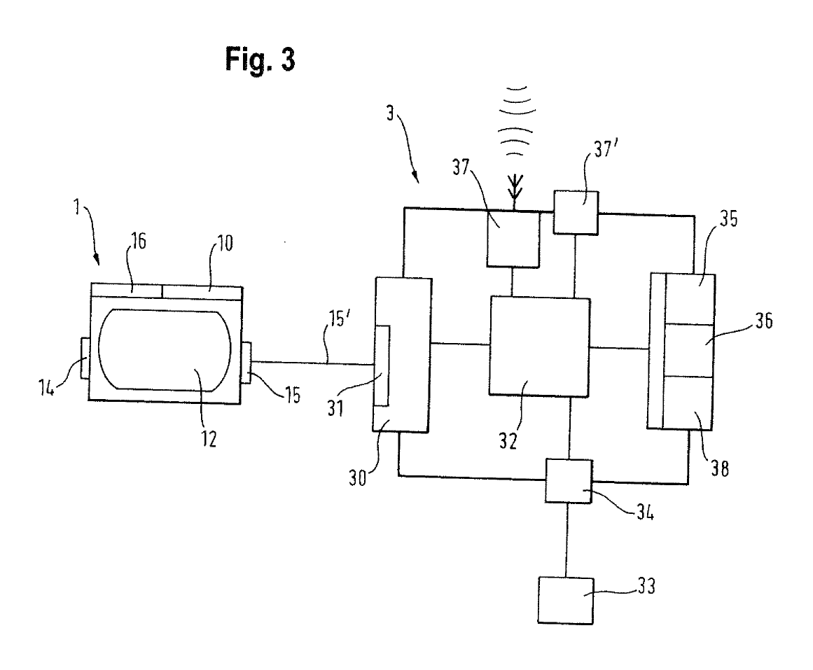

FIG. 3 is a schematic view of a scenario in which the control computer 1 is coupled to an operation vehicle computer 3 via a data communication connection 15′ by the data interface 15 thereof.

Even if the data communication connections 14′ and 15′ are shown in the embodiments as a physical connection, the data communication connections are not restricted to cable connections, but rather can equally be wireless data communication connections.

The operation vehicle computer 3 is installed for example in a military, shielded operation vehicle and has properties which are specific to the vehicle. For this purpose, the operation vehicle computer 3 is provided with a vehicle CPU 32 which is connected to an interface unit 30 for bidirectional data transmission. The interface unit 30 comprises a standardized control computer interface 31 which is configured for connection to one of the data interfaces 14, 15 of the control computer 1.

The operation vehicle computer 3 is equipped with a vehicle interface 34 which is connected to the vehicle CPU 32 for bidirectional data exchange. At least one vehicle component 33 of the operation vehicle can be connected to the vehicle interface 34. A vehicle component 33 of this type can be for example an onboard maintenance and diagnostic system which is thus integrated in the portable operation computer system.

Furthermore, the vehicle CPU 32 is equipped with a plurality of secondary interfaces. The secondary interfaces comprise for example a weapon system interface 35, a navigation interface 36 and/or a monitoring system interface 38. The above-mentioned secondary interfaces are not necessarily provided in all vehicles which are suitable for the use of the portable operation computer system, but rather the corresponding operation vehicle computer 3 can be configured so as to be adapted to the corresponding operation vehicle. It is thus for example not necessary to equip a vehicle, which is not configured as a weapon carrier or is not a command vehicle for a weapons operation, with a weapon system interface 35. Secondly, the control computer 1 which is connected to the operation vehicle computer 3 automatically detects whether an external component of a weapon system is connected to the weapon system interface 35.

Lastly, the operation vehicle computer 3 can also be equipped with a communication device or module 37 or can be connected to an external communication device via a communication device interface 37′. Both the communication device interface 37′ and the integrated communication device 37 which is optionally provided are connected to the vehicle CPU 32 for bidirectional data transmission.

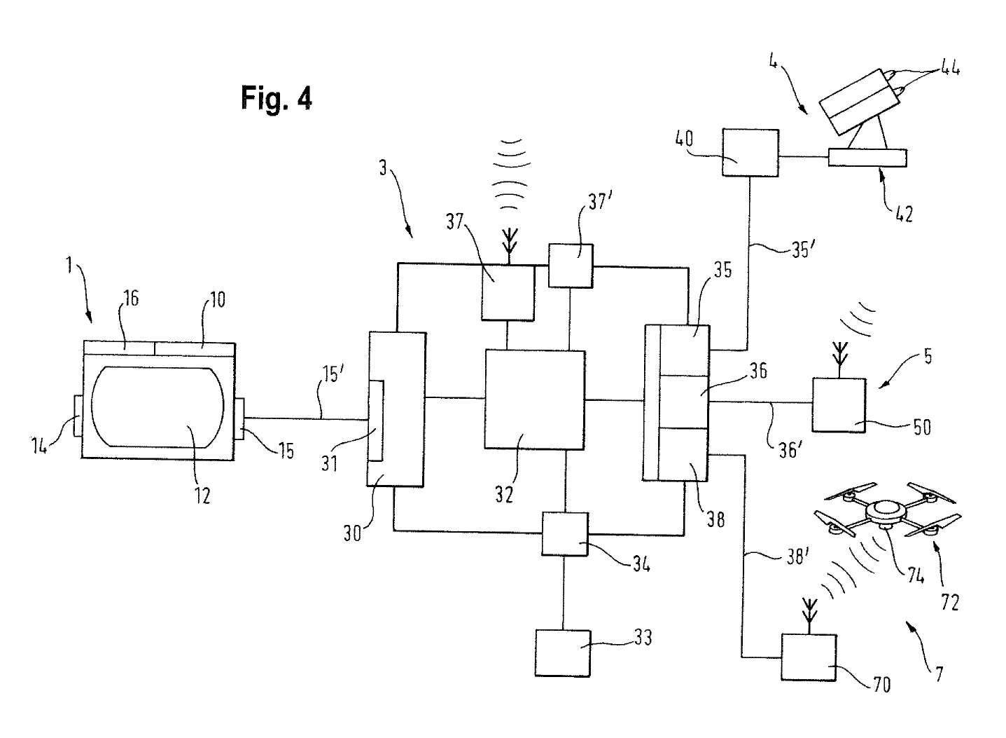

FIG. 4 shows the unit composed of a control computer 1 and an operation vehicle computer 3, wherein corresponding external components are connected to the secondary interfaces. The weapon system interface 35 is thus connected to a weapon system component 40 of a weapon system 4 via a wired or wireless data transmission connection 35′. The weapon system component 40 is formed for example of a weapon control system which is connected to a launching device or structure 42 for ammunition 44, for example missiles, for data transmission. The weapon system component 40 which is connected to the weapon system interface 35 can however also be formed of a control of the weapon system 4, or of a maintenance and diagnostic computer of the weapon system 4 or the ammunition 44 contained in the weapon system 4, or of a test and/or training apparatus of the weapon system or the ammunition 44 contained in the weapon system 4.

The navigation interface 36 of the operation vehicle computer 3 is connected to a navigation device component 50 of an internal or external navigation device 5, which component is formed for example of a navigation computer, via a data transmission connection 36′, which can likewise be wired or wireless. In vehicles which are already provided with a factory-integrated vehicle navigation system, the system can form the navigation device component 50.

The monitoring system interface 38 is connected to a monitoring component 70 of a monitoring system 7 by a data communication connection 38′, which can likewise be wired or wireless, for bidirectional data transmission. In the example shown, the monitoring component 70 is a control unit for a drone 72 which is equipped with a monitoring camera 74. Both the control signals for the drone 72 and for the camera 74 thereof and the image data which is recorded by the camera 74 are transmitted via a bidirectional radio link 76 between the drone 72 and the monitoring component 70 which is formed by the control unit. In this way, both the drone 72 and the camera 74 can be controlled by the control computer 1, and the images captured by the camera 74 can also be displayed on the display and control unit 12 of the control computer 1.

At least all the wireless data transmission connections comprise encryption and decryption units (not shown), which are configured to encrypt a data stream which is sent via the respective connections between the control computer 1 and the external component, between the control computer 1 and the operation vehicle computer 3 and/or between the operation control computer 3 and the external component, and to decrypt again a data stream which is received via the respective connections.

The control computer 1 which is connected to the operation vehicle computer 3, in a particularly preferred case, forms a digital vehicle assistant (DVA) as an audiovisual command, guidance and information center, which is provided in the preferably armored and air-conditioned driver cabin by large mobile devices of a tactical air defence system. The driver cabin also provides weather protection and CBRN protection for the operating personnel. The control computer 1 can be connected in the driver cabin to the operation vehicle computer 3 which is permanently installed in each vehicle and which is configured specifically to the vehicle or to the large devices.

The digital vehicle assistant (DVA) can be installed in the driver cabin of the following large mobile devices of a tactical air defence system:
utility vehicle comprising a tactical operations center (TOC)
utility vehicle comprising a search radar (SR)
utility vehicle comprising a guidance and tracking radar (FR)
reconnaissance utility vehicle
starting device utility vehicle
baggage utility vehicle
reloading utility vehicle
refuelling utility vehicle
energy supply utility vehicle (accompanying utility vehicle for TOC, SR, FR)
troop carrier utility vehicle
maintenance utility vehicle
rescue utility vehicle

The DVAs, i.e. the units composed of the respective control computers 1 and the respective operation vehicle computers 3, comprising the corresponding external components which are connected thereto of the respective large mobile devices, together form an example of a complex operation computer system according to the disclosure herein which can be put together in the manner of a construction kit. In this case, the specification of the functions which are accessible to the operator, and thus the menu hierarchy which is displayed on the display and control unit 12 of the control computer 1 and provided by the software running on the control computer 1 depends on the type of large device to which each control computer 1 is connected via the associated specific operation vehicle computer 3. The control computer and the software running thereon are identical and thus can be exchanged with each other as desired. The configuration of the software running on the control computer 1 takes place automatically in this case depending on the specific operation vehicle computer 3 which is connected to the control computer, and the external components which are connected thereto. Thus, even when preparing for an operation and throughout the entire operation, it is ensured that the data communication between all those involved in the operation is free of media disruption.

Reference numerals in the claims, the description and the drawings are used purely for a better understanding of the disclosure herein and are not intended to limit the scope of protection.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An operation computer system, comprising at least one control computer, which has a CPU, a display and control unit and at least one data interface, and comprising a plurality of external components which are connectable to the at least one data interface of the control computer, wherein the CPU is configured:
after the control computer has been switched on, or after an external component has been connected, to check whether the at least one data interface is connected to at least one of the external components and, if applicable, to which external component each data interface is directly or indirectly connected; and,
depending on a result of the check, to automatically select an operating mode for the control computer from a plurality of stored operating modes and to configure the control computer and/or software running on the control computer accordingly.

2. The operation computer system according to claim 1, wherein one of the external components is formed of a satellite navigation receiver.

3. The operation computer system according to claim 1, wherein one of the external components is formed of an operation vehicle computer which is provided in an operation vehicle, which is designed for coupling to the control computer and which is provided with an interface unit for connection to a data interface of the control computer, whereby the operation vehicle computer comprises a vehicle CPU which can be connected to the control computer by the interface unit and the data interface.

4. The operation computer system according to claim 3, wherein the operation vehicle computer is equipped with at least one vehicle interface which can be or is connected for data transmission between the control computer, which is connected to the operation vehicle computer, and at least one vehicle component of the operation vehicle.

5. The operation computer system according to claim 4, wherein the vehicle component which is or can be connected to the vehicle interface is formed of a maintenance and diagnostic computer of the vehicle.

6. The operation computer system according to claim 3, wherein the operation vehicle computer is equipped with at least one weapon system interface which is connectable to at least one weapon system component of the weapon system for data transmission between a weapon system and the control computer, which is connected to the operation vehicle computer.

7. The operation computer system according to claim 6, wherein the weapon system component connectable to the weapon system interface is formed of a control of the weapon system.

8. The operation computer system according to claim 6, wherein the weapon system component connectable to the weapon system interface is formed of a maintenance and diagnostic computer of at least one of the weapon system and the ammunition contained in the weapon system.

9. The operation computer system according to claim 6, wherein the weapon system component connectable to the weapon system interface is formed of a test and training apparatus of at least one of the weapon system and the ammunition contained in the weapon system.

10. The operation computer system according to claim 6, wherein the weapon system component connectable to the weapon system interface is formed of a test or training apparatus of at least one of the weapon system and the ammunition contained in the weapon system.

11. The operation computer system according to claim 3, wherein the operation vehicle computer is equipped with at least one navigation interface connectable to at least one navigation device component of the at least one navigation device for data transmission between at least one internal or external navigation device of the operation vehicle and the control computer, which is connected to the operation vehicle computer.

12. The operation computer system according to claim 3, wherein the operation vehicle computer is equipped with or can be connected to at least one communication device which is connectable to at least one communication component of the at least one external operation control center for data transmission between at least one external operation control center and the control computer, which is connected to the operation vehicle computer.

13. The operation computer system according to claim 3, wherein the operation vehicle computer further comprises at least one monitoring system interface connectable to at least one monitoring component of the monitoring system for data transmission between at least one monitoring system and the control computer, which is connected to the operation vehicle computer.

14. The operation computer system according to claim 13, wherein the monitoring component connectable to the monitoring system interface is formed of a missile equipped with a reconnaissance device of the monitoring system.

15. The operation computer system according to claim 1, wherein encryption and decryption units are further provided, which are configured to encrypt a data stream which is sent via the respective connections between the control computer and the external component, between the control computer and the operation vehicle computer and/or between the operation control computer and the external component, and to decrypt a data stream which is received via the respective connections.

16. The operation computer system according to claim 1, wherein a reconnaissance device for recording data is provided which each comprise a data recording component connectable to at least one of the control computer and to the operation vehicle computer for data transmission.

17. The operation computer system according to claim 1, wherein the operation computer system is provided for military deployments.
